(19) United States
(12) Patent Application Publication
(10) Pub. No.: US 2005/0064972 A1
(43) Pub. Date: Mar. 24, 2005

(54) [Three Piece Timing Pulley Assembly containing one Inner Positive Drive Hubless and Flangeless Timing Pulley and two Outer Driven, Positive Drive, and Synchronized Timing Pulleys]

(75) Inventors: Waleed Khaled Rusheidat, Odessa, FL (US); Antonio Gutierrez, Tampa, FL (US); John James Johnson, Odessa, FL (US)

Correspondence Address: QUANTUM ENGINEERING INTERNATIONAL, 15921 MUIRFIELD DRIVE, ODESSA, FL, 33556, US

(73) Assignee: QUANTUM ENGINEERING INTERNATIONAL, Odessa, FL (US)

(21) Appl. No.: 10/605,334

(22) Filed: Sep. 23, 2003

(51) Int. Cl. F16H 55/50; F16H 55/30

(52) U.S. Cl. 474/168; 474/152

(57) ABSTRACT

This hybrid pulley assembly is comprised of two outer driven synchronized timing pulleys and a centerpiece inner driver timing pulley. This pulley assembly operates in such a manner where the input driving timing belt mounted on the centerpiece timing pulley positively drives the outer synchronized timing pulleys. An outer driven timing belt, which is mounted on the outer driven timing pulleys and across the centerpiece driver timing belt, is partially supported by the centerpiece driver timing belt top surface in the area enclosed by the two outer synchronized timing pulleys. This configuration allows this hybrid pulley assembly to be driven from within. This alleviates the need of conventional drive train systems where a timing driven belt is driven through an axial input to the driven timing pulley.

### BACKGROUND OF INVENTION

This invention applies to “A Belt and Pulley Positive Drive System.” The field of this invention falls within the U.S. patent Classification Definition of “CLASS 474 ENDLESS BELT POWER TRANSMISSION SYSTEMS” OR COMPONENTS “Subclass “152 POSITIVE DRIVE PULLEY OR GUIDE ROLL”.

The problems related to Timed Pulleys, which this invention provides a solution to, are as follows:

When the Pulley(s) in a timed belt driven system is mounted in a confined space, there maybe no provision to drive the Pulley directly by means of a motor connected shaft mounted or connected to the timing pulley.

When the timing belt is cleated or the non-timed side of the belt not being Flat, the belt cannot be driven by friction applied through a tensioned pulley connected to the driving motor or gear head. This constraint coupled with limited space around the timing pulley makes it impossible for a direct drive to this said pulley.

### SUMMARY OF INVENTION

This invention constitutes of Three Timing Pulleys where the Centerpiece-Timing Pulley is driving the Outer-Timing Pulleys. The Centerpiece Timing Pulley does not have to be synchronized with respect to the Outer-Timing Pulleys. However, the Outer-Timing Pulleys are synchronized with respect to each other.

This allows the drive (whether a motor shaft or gear head) to be remotely located from the Centerpiece-Timing Pulley when the space around the Outer Timing Pulleys is confined and/or the timing belt does not have a flat surface to which a friction drive mechanism could be applied.

### BRIEF DESCRIPTION OF DRAWINGS

FIG. 1: The Apparatus displayed on FIG. 1 shows the three pieces of the Timing Pulley Assembly placed on top of each other. The only purpose for this Figure is to display the Centerpiece-Timing Pulley's 2 position within the above-mentioned Three Piece Timing Pulley Assembly.

FIG. 2: The Apparatus according to FIG. 2 displays all the characteristics of FIG. 1 with one added feature. This added feature has provisions for proper Outer-Timing Pulleys' 4 & 6 Synchronization. The machined drive shaft bore and key way throughout the entire Three Piece Timing Pulley Assembly achieves this Timed Synchronization. All items discussed in this said Brief FIG. 2 are described and shown on this said Figure.

FIG. 3: The Apparatus according to FIG. 3 displays all the characteristics of FIG. 2 with one added feature and one removed feature. This added feature has provisions for proper Outer-Timing Pulleys' 8 & 30 Synchronization. The installed three Roll-Pins 14 or Dowel Pins 14 throughout the entire Three Piece Timing Pulley Assembly achieves this Timed Synchronization. The key way feature has been removed in this said Figure. View III of this said FIG. 3 shows a sectional view of this said Hybrid Pulley Assembly with the Drive Shaft 90 removed for clarification of the location of the third Dowel Pin 14. All items discussed in this said Brief FIG. 3 are described and shown on this said Figure.

FIG. 4: The Apparatus according to FIG. 4 displays all the characteristics of FIG. 2 with one added features and one removed feature. This added feature has provisions for proper Outer-Timing Pulleys' 9 & 11 Synchronization. The installed Three Mounting Screws throughout the entire Three Piece Timing Pulley Assembly achieves this Timed Synchronization. The removed feature is the key way in this said Figure. View IV of this said FIG. 4 shows a sectional view of this said Hybrid Pulley Assembly with the Drive Shaft 90 removed for clarification of the location of the third Machine Screw 13. All items discussed in this said Brief FIG. 4 are described and shown on this said Figure.

FIG. 5: The Apparatus according to FIG. 5 displays all the characteristics of FIG. 2 with two added features and one removed feature. This first added feature has provisions for proper Outer-Timing Pulleys' 50 & 51 Synchronization. The installed three Mounting Screws 13 located throughout the entire Three Piece Timing Pulley Assembly, achieves this Timed Synchronization. The second added feature is the Mounting Shaft Bearings 12. The removed feature is the key way in this said Figure. View V of this said FIG. 5 shows a sectional view of this said Hybrid Pulley Assembly with the Drive Shaft 90 removed for clarification of the location of the third Machine Screw 13. All items discussed in this said Brief FIG. 5 are described and shown on this said Figure.

FIG. 6: The Apparatus according to FIG. 6 displays one Hybrid Pulley Assembly, one Inner Drive Timing Belt 16, and one Outer Driven Timing Belt 15. On this said Figure number 6, one of the applications of this hybrid pulley assembly is illustrated. This said application is displayed on FIG. 6. There is only one Driven Outer Timing Belt 15 used for a selected process.

FIG. 6: The Apparatus according to FIG. 6 also displays the capability of driving this said Hybrid Pulley Assembly from within the Assembly. This said internal Centerpiece-Timing Pulley 5 will provide the power to the Outer Timing Pulleys 4 & 6, and Outer Driven Timing Belt 15.

FIG. 7: The Apparatus according to FIG. 7 displays all the characteristics of FIG. 6 with one different application and one added feature. This said figure illustrates a different application, which constitutes of two Outer Driven Timing Belts 17 & 18. This said added feature constitutes of adding an inner flange to each of the two outer driven pulleys 4 and 6.

FIG. 8: The Apparatus according to FIG. 8 displays the two raw pulleys used in the manufacturing of the said Hybrid Pulley. This said Figure illustrates the raw Driven Source Pulley 19 and the raw Drive Source Pulley 20 respectively. This said FIG. 8 displays the machining of the drive shaft bore and the key way throughout the entire width of these said raw pulleys. All items discussed in this said FIG. 8 are described and shown on this said Figure.

FIG. 9: The Apparatus according to FIG. 9 displays all the characteristics of FIG. 8 with one added feature and one removed feature. The said added feature is the machining of three small bores which are used for alignment and attachment. Two of the said three bores are located at 110 degrees from each other. The third bore is located at 125 degrees from the first two. The said removed feature is the key way. Views XII and XV of this said Figure illustrate the raw Driven Source Pulley 21 and the raw Drive Source Pulley 22 respectively. Views XII and XIV display the machining of the drive shaft bore and the three said small bores throughout the entire width of these said raw pulleys 21 & 22. All items discussed in this said FIG. 9 are described and shown on this said Figure.

FIG. 10: The Apparatus according to FIG. 10 displays all the characteristics of FIG. 8 with one added feature and one removed feature. The said added feature is the machining of three small bores which are used for alignment and attachment. Two of the said three bores are located at 110 degrees from each other. The third bore is located at 125 degrees from the first two. The said removed feature is the key way. Views XVII and XIX illustrate the raw Driven Source Pulley 24 and the raw Drive Source Pulley 25 respectively. Views XVI thru XVIII display the machining of the drive shaft bore and the three said small bores throughout the entire width of these said raw pulleys. On this said raw Driven Source Pulley 24, the three said small bores are counter-sunk from one side of this said raw Driven Source Pulley 24. All items discussed in this said FIG. 10 are described and shown on this said Figure.

FIG. 11: The Apparatus displayed on FIG. 11 shows the same characteristics of FIG. 6 with respect to the Hybrid Pulley Assembly. However, on this said FIG. 11, a Drive Source Timing Pulley 26 is remotely located from the Hybrid Pulley Assembly. This said FIG. 11 illustrates one of the possible configurations of applying this Hybrid Pulley Assembly in a belt driven system.

FIG. 12: The Apparatus displayed on FIG. 12 shows the same characteristics of FIG. 7 with respect to the Hybrid Pulley Assembly. However, on this said FIG. 12, a Drive Source Timing Pulley 26 is remotely located from the Hybrid Pulley Assembly. This said FIG. 12 illustrates a second possible configuration for applying this Hybrid Pulley Assembly in a belt driven system. View XXI Illustrate the drive shaft 91 and the drive shaft key 92 in this said Hybrid Pulley Assembly.

FIG. 13: The Formula displayed on FIG. 13 is used to calculate the Driven Pulley's diameter.

### DETAILED DESCRIPTION

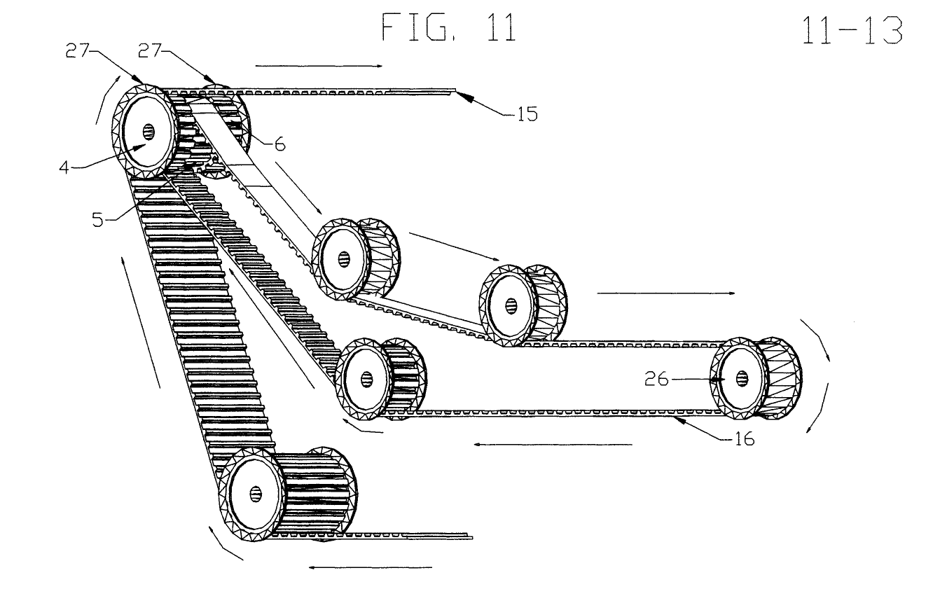

FIG. 11 shows an example of a method for applying this Three Piece Timing Pulley Assembly in a drive train system. The Centerpiece-Timing Pulley 5 will only drive the Outer Driven Timing Pulleys 4 & 6. The Inner Drive Timing Belt 16, which is connected to a Drive Source Pulley 26 that is driven by a motor shaft or a gear head, positively drives the Centerpiece-Timing Pulley 5. The axial position of the timing teeth of the Driven Pulleys 4 & 6 does not have to be synchronized with respect to the Drive Pulley 5 timing teeth. It is the fixed relative axial position between the Drive Pulley 5 teeth and the teeth of the Driven Pulleys 4 & 6 that guarantees the positive drive and fixed relative timing between the Drive Pulley 5 and the Driven Timing Pulleys 4 & 6. The outer Driven Pulleys 4 & 6 drive one Outer Driven Timing Belt 15. The Outer Driven Timing Pulleys 4 & 6 are equipped each with an outer Flange 27.

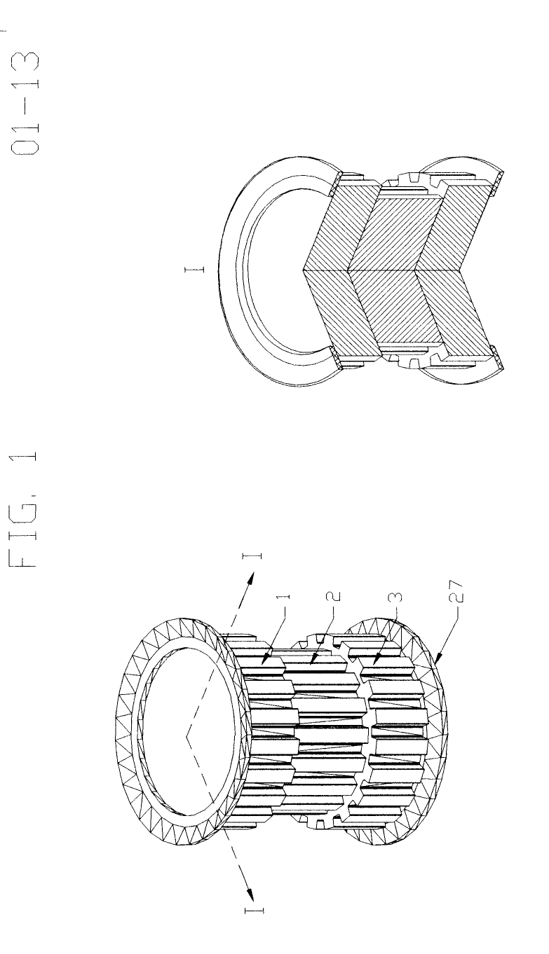

FIG. 1 illustrates the constructional sequence of this said Three Piece Timing Pulley Assembly. The two Outer-Timing Pulleys 1 & 3 are the Driven Synchronized Pulleys and the Centerpiece-Timing Pulley 2 is the Drive Pulley. This Three Piece Timing Pulley Assembly may be referred to throughout the context of this document as Compound Pulley Assembly, a Hybrid Pulley Assembly, or a Synchronized Timing Pulley Assembly. The Outer Driven Timing Pulleys 1 & 3 are equipped each with an outer Flange 27.

In FIG. 1, the Centerpiece-Timing Pulley 2 may be referred to throughout the context of this document as Drive Pulley, Driver Pulley, Inner Drive Pulley, or Inner Driver Timing Pulley.

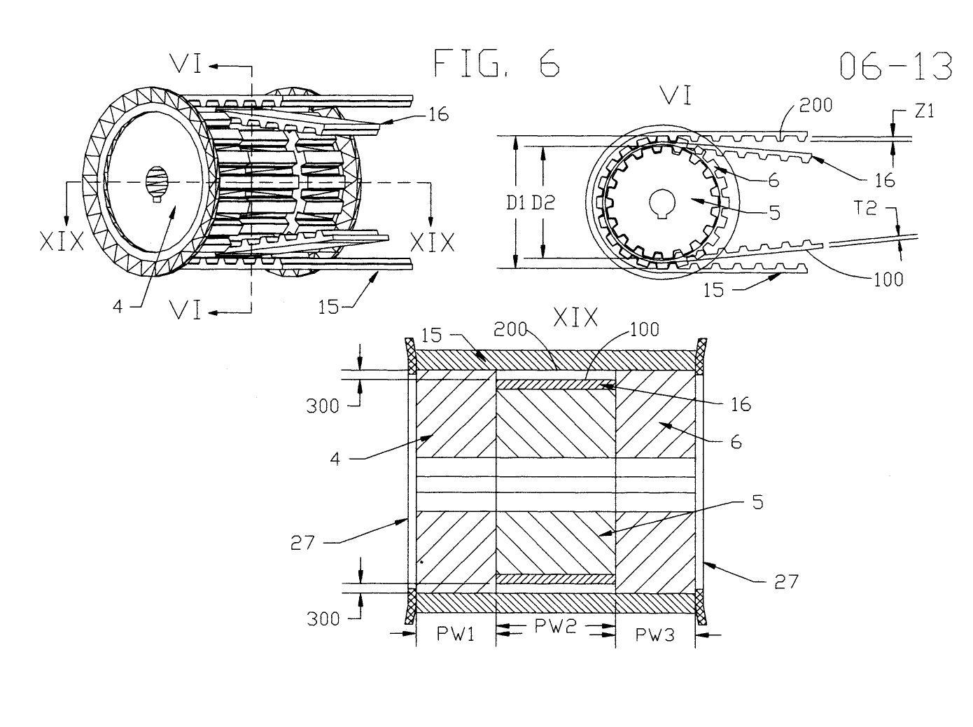

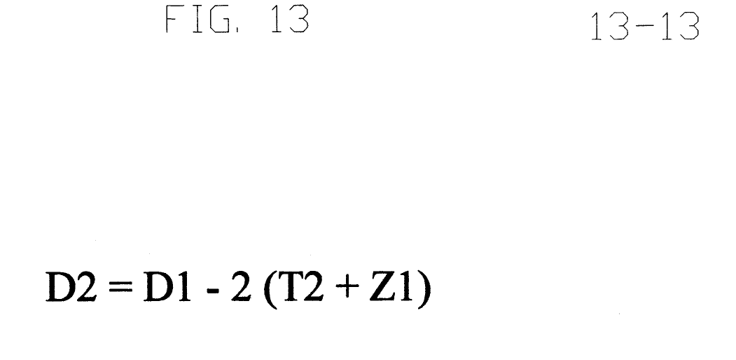

In FIG. 6 with its respective cross sectional view VI for this said Hybrid Pulley Assembly, displays the Inner Driver Pulley 5 outside diameter D2. This outside diameter D2 is limited by the Outer Driven Timing Pulley 6 outside diameter D1, less twice the tooth depth Z1 of the Driven Timing Belt 15, and less twice the belt thickness T2 of the Driver Timing Belt 16. The outside diameter D2 of this said Inner Driver Timing Pulley 5 can be calculated using the formula displayed in FIG. 13.

In FIG. 6 with its respective cross sectional view XIX for this said Hybrid Pulley Assembly, it displays the application with one Outer Driven Timing Belt 15. In this case, the width of this said Outer Driven Timing Belt 15 dictates the overall width of this said Hybrid Pulley Assembly. This said overall width is the sum of the width PW1 of the first Outer Timing Pulley 4, the width PW2 of the Inner Driver Timing Pulley 5, the width PW3 of the second Outer Timing Pulley 6, and a belt relief. Therefore, in most cases, the width of the Outer Driven Timing Belt 15 is less than the width of the Hybrid Pulley Assembly. For example, a T5 timing belt width is 5 mm less than that of a timing pulley width, which is a typical recommendation set by timing belt manufacturers.

In FIG. 6 with its respective cross sectional view VI for this said Hybrid Pulley Assembly, it displays the said Inner Drive Timing Belt 16, the Outer Driven Timing Belt 15, the Outer Driven Timing Pulleys 6, and the Inner Driver Timing Pulley 5. In this said view VI, the top surface of the Inner Drive Timing Belt 16 defines the Interface Drive Plane 100 and the bottom surface of the timing teeth of the Outer Driven Timing Belt 15 defines the Interface Driven Plane 200.

In FIG. 6 with its respective cross sectional view XIX for this said Hybrid Pulley Assembly, it displays the said Inner Drive Timing Belt 16, the Outer Driven Timing Belt 15, the Outer Driven Timing Pulleys 4 & 6, the Inner Driver Timing Pulley 5, the outer Flanges 27, the Interface Drive Plane 100, the Interface Driven Plane 200, and the enclosed Hybrid Pulley Interface Gap 300. In an ideal configuration, when the formula in FIG. 13 is satisfied, this said Interface GAP 300 would equal to zero. However, if the Outer Diameter D2 of the Inner Drive Pulley 5 calculated by the formula displayed in FIG. 13 is not available, the next available lower Outer Diameter could be used with a constraint. This said constraint is the size of the said Hybrid Pulley Interface Gap 300 that is created between the said Interface Drive Plane 100 and the said Interface Driven Plane 200. This said constraint must not exceed the maximum unsupported deflection value recommended by the manufacturer of the Outer Driven Timing Belt 15. In addition, even if the Diameter D2 of the Inner Driver Timing Pulley 5 satisfies the formula displayed in FIG. 13, the stack of tolerances for the Inner Driver Timing Pulley 5 diameter D2, the Inner Drive Timing Belt 16 thickness T2, and the Outer Driven Timing Pulleys 4 & 6 diameter D1 will create this said Interface Gap 300. Typically, this stack of tolerance could total 0.020″, which leads to an Interface Gap 300 of 0.020″ that would be acceptable for most timing belts with steel reinforcement.

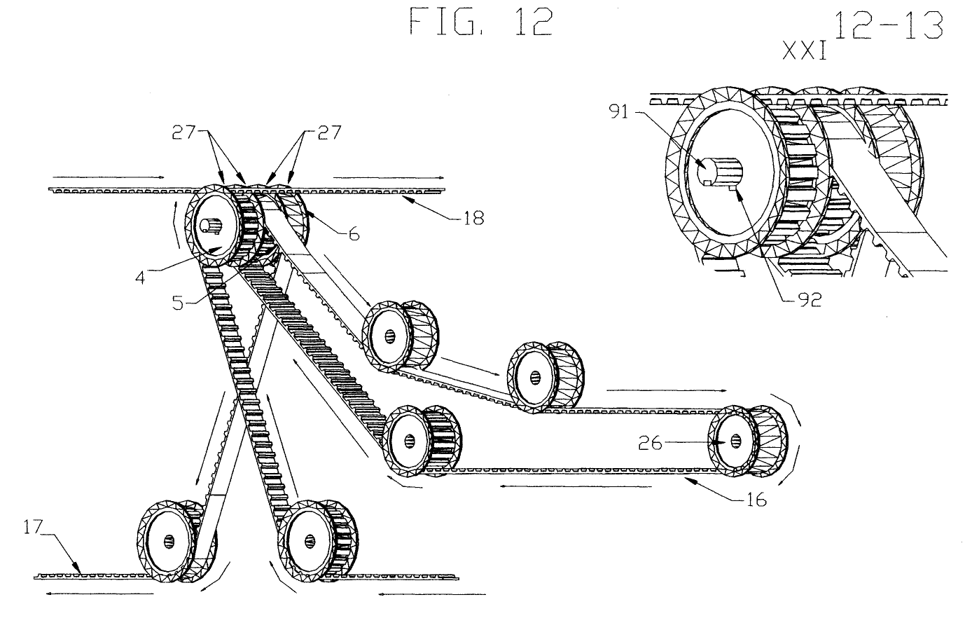

FIG. 12 shows an example of another method of applying this Three Piece Timing Pulley Assembly in a drive train system. The Centerpiece-Timing Pulley 5 will only drive the outer Driven Timing Pulleys 4 & 6. The Inner Drive Timing Belt 16, which is connected to a Drive Source Pulley 26 that is driven by a motor shaft or a gear head, positively drives the Centerpiece-Timing Pulley 5. The axial position of the timing teeth of the Driven Pulleys 4 & 6 does not have to be synchronized with respect to the Drive Pulley 5 timing teeth. It is the fixed relative axial position between the Drive Pulley 5 teeth and the teeth of the Driven Pulleys 4 & 6 that guarantees the positive drive and fixed relative timing between the Drive Pulley 5 and Driven Timing Pulleys 4 & 6. The Outer Driven Timing Pulley 4 will drive an Outer Driven Timing Belt 18, and the Outer Driven Timing Pulley 6 will drive an Outer Driven Timing Belt 17. These two Outer Driven Timing Belts are synchronized.

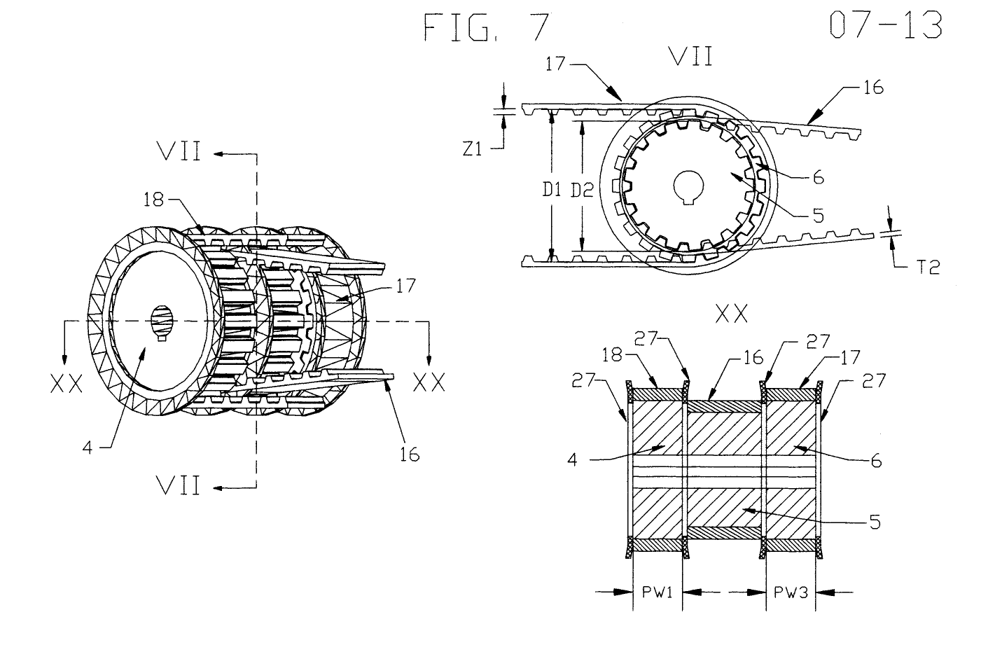

In FIG. 7 with its respective cross sectional view VII for this said Hybrid Pulley Assembly displays the Inner Driver Pulley 5 outside diameter D2. This outside diameter D2 is limited by the Outer Driven Timing Pulley 6 outside diameter D1, less twice the tooth depth Z1 of the Driven Timing Belts 17 or 18, and less twice the belt thickness T2 of the Driver Timing Belt 16. The outside diameter D2 of this said Inner Driver Timing Pulley 5 can be calculated using the formula displayed in FIG. 13.

In FIG. 7 with its respective cross sectional view XX for this said Hybrid Pulley Assembly displays the application with Two Outer Driven Timing Belts 17 and 18. In this case, the width of the Outer Timing Belt 17 dictates the width PW3 of the Outer Timing Pulley 6. The width of the Outer Timing Belt 18 dictates the width PW1 of the Outer Timing Pulley 4. The one additional feature that this said FIG. 7 displays, which is not featured on FIG. 6 for the single driven outer belt Hybrid Pulley Assembly, is the addition of the inner Flanges 27 to the inner sides of the Outer Driven Timing Pulleys 4 & 6.

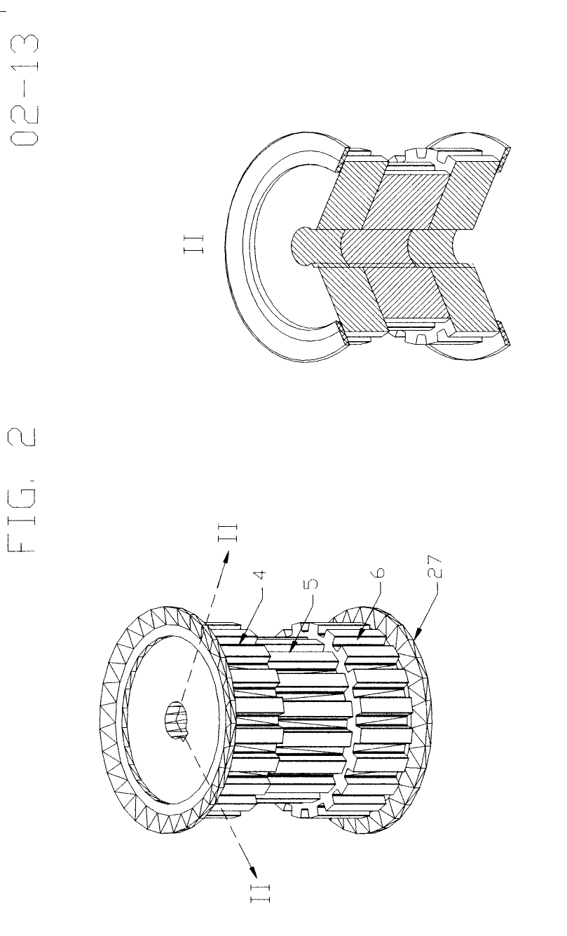

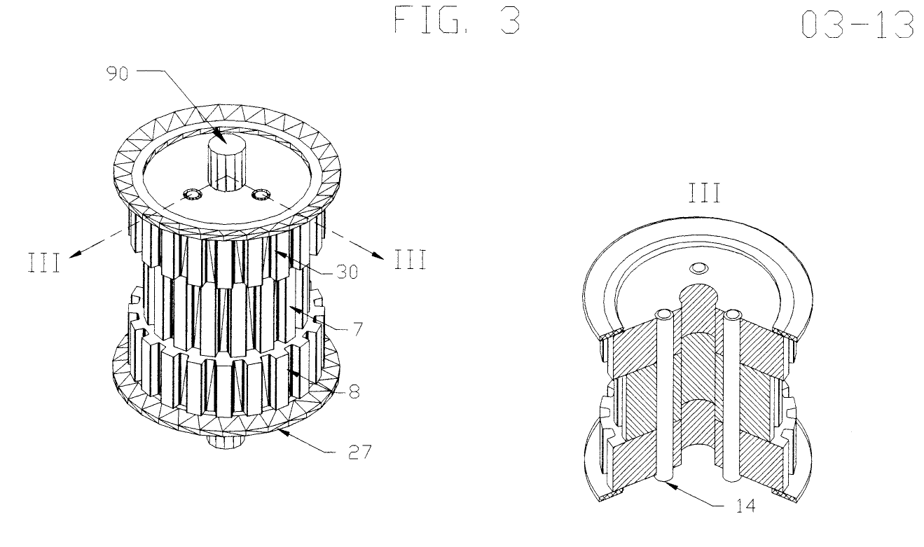

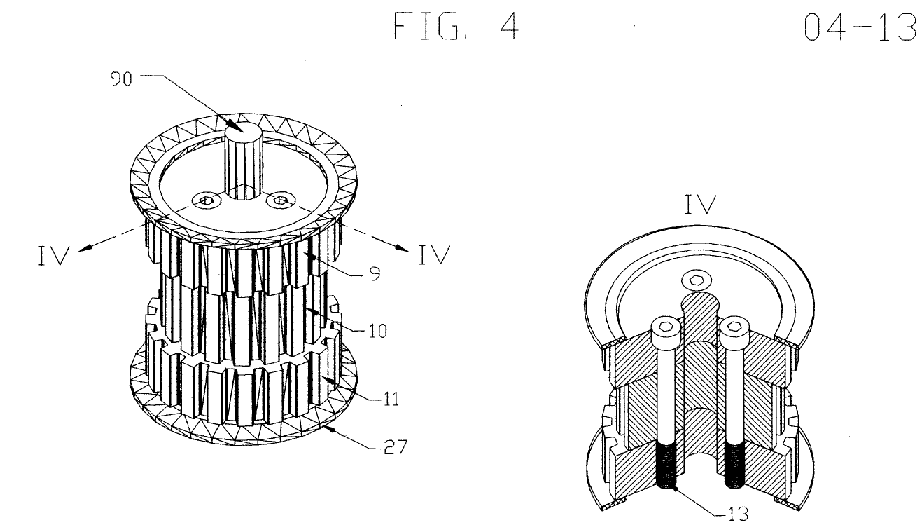

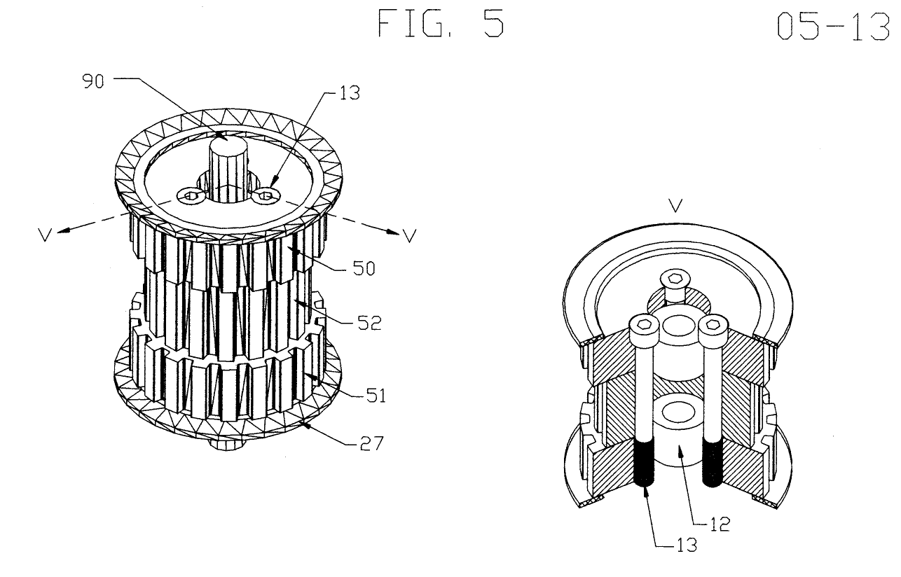

The following paragraph explains how to prepare for making either of the following Inner Driver Pulleys; 5 in FIG. 2, 7 in FIG. 3, 10 in FIG. 4, or 52 in FIG. 5.

Obtain a timing pulley whose material (Aluminum, Steel, Nylon, etc.), tooth profile, and outside diameter D2 is sized for the Driver Timing Belt 16, which is selected by the designer or specified by its application. The Diameter of this said pulley D2 will be obtained by the Formula in FIG. 13. This said Timing Pulley could be purchased as a stand-alone pulley whose width is PW2 or as a timing pulley stock that will be cut to a width of PW2. This said Timing Pulley may be referred to throughout the context of this document as Driver Source Pulley.

The following paragraphs explain how to make either of the Outer Driven Timing Pulley sets 4 & 6, 8 & 30, 9 & 11, or 50 & 51.

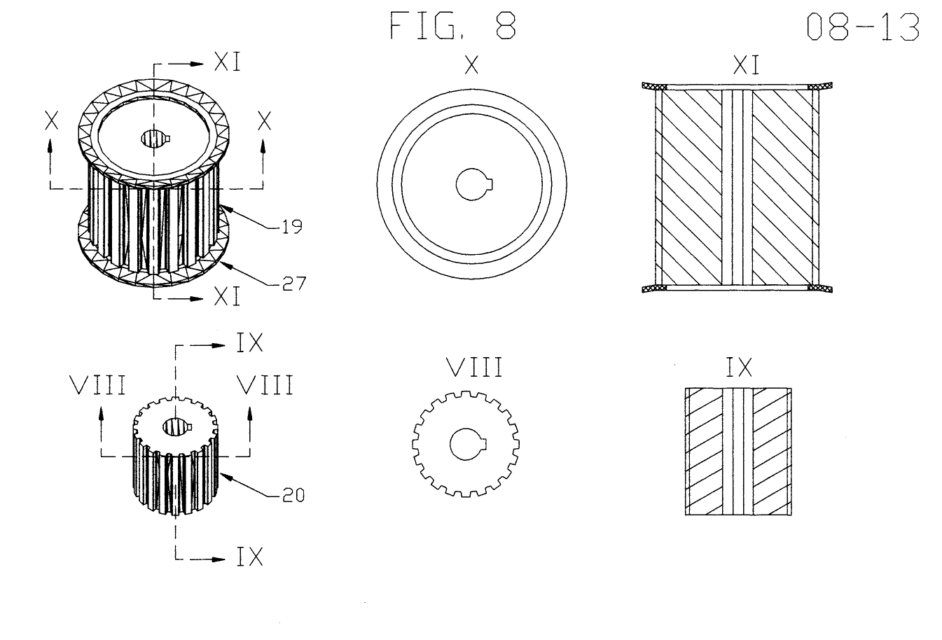

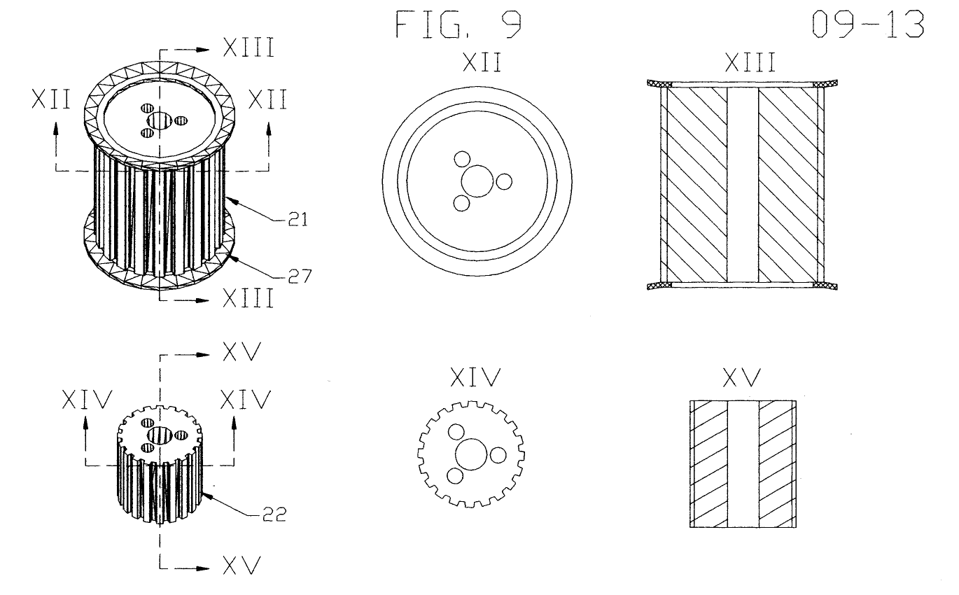

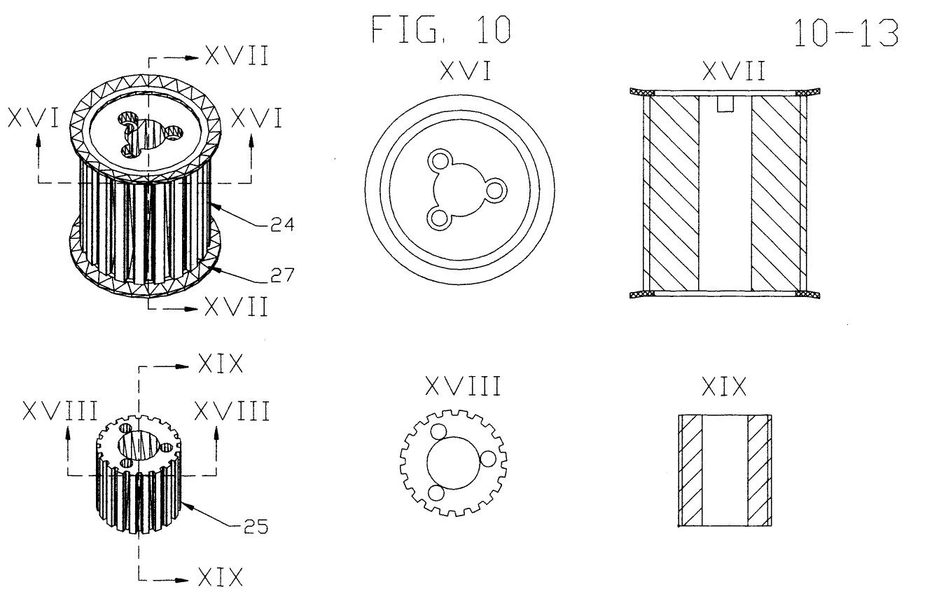

Obtain a Timing Pulley whose material (Aluminum, Steel, Nylon, etc.), tooth profile, and outside diameter D1 is sized for the Driven Timing Belt, which is selected by the designer or specified by its application. This said Timing Pulley could be purchased as a stand-alone pulley with outer Flanges 27 as depicted in FIG. 8, FIG. 9, and FIG. 10, or as a timing pulley stock. This said Timing Pulley stock or this said stand-alone pulley may be referred to throughout the context of this document as Driven Source Pulley.

The Driven Source Pulley width must be at a minimum the sum of PW1, PW3, belt relief, and the cutting gap requirement. This said cutting gap distance is dependant on the cutting method to be adopted. This said cutting gap requirement could be 0.250-inch minimum inclusive of the width of the cutting tool used.

This said Driven Source Pulley must be cut to produce two pulleys whose widths are PW1 & PW3. However, prior to cutting this said Driven Source Pulley, the two pieces to be produced from this said Driven Source Pulley must be referenced for synchronization. Three methods for referencing and guaranteeing the synchronization are listed below. Other methods for synchronization can be used as long as they yield the same results obtained below.

Synchronization Method One: In FIG. 8, if the said Driven Source Pulley 19 does not have a pilot bore, then drill a pilot bore. This said pilot bore diameter is dictated by the keyed shaft 91 diameter depicted in FIG. 12. A shaft key way must be machined from one end to another in this said Driven Source Pulley 19. The size of the shaft key way is determined by the application and limited by the size of the Driver Source Pulley 20. The said Driver Source Pulley 20 must have a pilot bore drilled and a shaft key way machined identical to that of the said Driven Source Pulley 19.

Synchronization Method Two: In FIG. 9, if the said Driven Source Pulley 21 does not have a pilot bore, then drill a pilot bore. This said pilot bore diameter is dictated by the drive shaft 90 diameter depicted in FIG. 3. Three pilot bores are drilled into this said Driven Source Pulley 21. Two of the said three bores are located at 110 degrees from each other. The third bore is located at 125 degrees from the first two. The angular spacing selected here is a preference. Other Angular spacing could be used as long as the holes are not distributed symmetrically around the pulley axis. These holes could be located on a circle whose diameter is ⅔ of that of the outer diameter D2 of the Driver Source Pulley 22. In addition, the diameter of the three pilot holes could be ⅛″ (0.125″) but other sizes may be selected depending on the application. The said Driver Source Pulley 22 must have a pilot bore and three pilot holes drilled identical to that of the said Driven Source Pulley 21.

Synchronization Method Three: In FIG. 10, if the said Driven Source Pulley 24 does not have a pilot bore, then drill a pilot bore. This said pilot bore diameter is dictated by the drive shaft 90 diameter depicted in FIG. 4 or by the Drive Shaft Bearings 12 outer diameter depicted in FIG. 5. Three pilot holes are drilled into this said Driven Source Pulley 24. Two of the said three bores are located at 110 degrees from each other. The third bore is located at 125 degrees from the first two. The angular spacing selected here is a preference. Other Angular spacing could be used as long as the holes are not distributed symmetrically around the pulley axis. These holes could be located on a circle whose diameter is ⅔ of that of the outer diameter D2 of the Driver Source Pulley 25. The Tap Drill Size for the Mounting Screws 13 selected for this application determines the diameter of the said three pilot holes. For example, a ¼-20 UNC Machine Screw requires a pilot hole diameter of 0.201″ or drill #7. One side of this said Driven Source Pulley 24 would have the three pilot holes counter-sunk to burry the head of the said Mounting Screws 13. See FIG. 4 or FIG. 5 for machine screw application. Then, on this said side, three pilot holes will be oversized to a diameter equal to the outer body diameter of the selected Machine Screws 13. However, this secondary drilling operation will be at a controlled depth or distance equal to the width of the Outer Driven Pulleys 9 or 50 depicted in FIG. 4 and FIG. 5 respectively. The other side of this said Driven Source Pulley 24 would have the three pilot holes tapped to the selected thread size and overall thread length of the Outer Driven Pulleys 11 or 51 depicted in FIG. 4 and FIG. 5 respectively. The said Driver Source Pulley 25 must have a pilot bore drilled identical to that of the said Driven Source Pulley 24. This said Driver Source Pulley 25 must have three pilot holes drilled identical in location to that of the said Driven Source Pulley 24. However, the said three pilot holes' diameter must be equal to that of the diameter of the said Machine Screw 13 outer body diameter.

FIG. 2 shows this said Hybrid Pulley Assembly with a pilot bore and a key way design, which is one of the Synchronization Methods. The front cross-sectional view II of this said FIG. 2 illustrates how the pilot bore and key way extend throughout the three pieces that constitute this Hybrid Pulley Assembly; the two Outer-Timing Pulleys 4 & 6 and the Centerpiece Timing Pulley 5. The Outer Driven Timing Pulleys 4 & 6 are equipped each with an outer Flange 27.

The said Driven Source Pulleys 19 in FIG. 8, 21 in FIG. 9, and 24 in FIG. 10 will have two pieces cut from it to produce two timing pulleys whose widths are PW1 & PW3 as depicted in FIG. 6 or FIG. 7. EDM is the preferred method of cutting since it yields lower stress on the pulley's timing teeth, which minimizes tooth distortion. Other methods of cutting can be used as long as they do not distort any of the pulley's timing teeth.

FIG. 12 shows the three pieces of the timing pulleys 4, 5 and 6 assembled into the said Hybrid Pulley Assembly using a drive shaft 91 and a key 92. If the Driven Source Pulley 19 was obtained from a pulley stock, the outer Flanges 27 can now be drilled in order to be mounted onto the produced Outer Driven Timing Pulleys 4 & 6 respectively. View XXI of this said FIG. 12 provides further clarification on the location of this said Drive Shaft 91 and Key 92. The Three Piece Hybrid Pulley assembly is now available for use.

FIG. 4 shows the Three Piece Hybrid Pulley Assembly utilizing the Machine Screw method of synchronization. View IV of this said figure shows a sectional view of this said Hybrid Pulley Assembly, which comprises of Machine Screws 13. The Outer Driven Timing Pulleys 9 & 11 are equipped each with an outer Flange 27.

FIG. 5 shows the Three Piece Hybrid Pulley Assembly utilizing the Machine Screw method of synchronization. View V of this said figure shows a sectional view of this said Hybrid Pulley Assembly, which comprises of Machine Screws 13, and Drive Shaft Bearings 12. Additional attention has to be placed to the location of the mentioned Mounting Shaft Bearings 12 in the bore of each timing pulley. The Bearing position accomplishes the proper alignment of the Centerpiece-Timing Pulley 52 with respect to each of the Outer-Timing Pulleys 50 & 51. This is critical because there will be no timing belt or timing pulley binding resulting between the Drive Shaft 90 displayed in FIG. 5 and the Mounting Shaft Bearings 12. The Outer Driven Timing Pulleys 50 & 52 are equipped each with an outer Flange 27.

FIG. 3 shows the Three Piece Hybrid Pulley Assembly utilizing the Dowel Pin method of synchronization. View III of this said figure shows a sectional view of this said Hybrid Pulley Assembly with the Dowel Pins 14 inserted through the three pieces of this said Hybrid Pulley Assembly. The Outer Driven Timing Pulleys 30 & 8 are equipped each with an outer Flange 27.

1. A three piece timing pulley assembly that is comprised of:
A Centerpiece Hubless and Flangeless Inner Driver Timing Pulley.
Two Outer Driven Synchronized Timing Pulleys.
The Inner Driver Timing Belt is mounted on the Inner Driver Timing Pulley.
The Outer Driven Timing Belt is mounted on the Synchronized Outer Driven Timing Pulleys.

2. The Outer Driven Synchronized Timing Pulleys of claim 1 are positively driven from within the apparatus described in claim 1 by the Centerpiece Inner Driver Timing Pulley as follows:
The Inner Driver Timing Pulley diameter in claim 1 is less than that of the Outer Driven Synchronized Timing Pulleys diameter in claim 1.
The Inner Driver Timing Pulley diameter is such that the top surface of the mounted Inner Driver Timing Belt supports the bottom teeth of the mounted Outer Driven Timing Belt.
The Outer Driven Timing Belt is partially supported by the said Inner Driver Timing Belt.
The Inner Driver Timing Belt is remotely driven by a timing pulley connected to a motor shaft or a gear head shaft.

3. The apparatus in claim 2 defines and comprises the following planes:
The top surface of this said Inner Drive Belt defines the Interface Drive Plane.
The bottom surface of this said Outer Driven Timing Belt timing teeth defines the Interface Driven Plane.
The said Interface Driven Plane and the said Interface Driver Plane enclose the Interface Gap.

4. According to claim 3, this said Interface Drive Plane width is confined within the space occupied by the Outer Driven Timing Belt, which allows this said Hybrid Pulley Assembly thereof to be driven from within the apparatus in claim 1.
